(19) United States
(12) Patent Application Publication
(10) Pub. No.: US 2026/0182502 A1
(43) Pub. Date: Jul. 2, 2026

(54) STOWABLE CUTTING TOOL

(71) Applicant: JAMESON, LLC, Clover, SC (US)

(72) Inventors: Carlos Fernando Becerra Alvarado, Charlotte, NC (US); Blake Andrew Tomlinson, Statesville, NC (US); Min-Guang Chao, Nantou City (TW)

(21) Appl. No.: 18/496,989

(22) PCT Filed: Sep. 22, 2023
(86) PCT No.: PCT/US2023/074917

§ 371 Date: Oct. 30, 2023

(51) Int. Cl. A01G 3/08; F16B 7/04

(52) U.S. Cl. CPC A01G 3/083; F16B 7/042

(57) ABSTRACT

A cutting tool system includes a cutting tool and optionally a longitudinally extending pole. The cutting tool includes a handle assembly and a blade. The handle assembly has a rearward proximal extension, a forward distal end longitudinally opposite the proximal extension, and a scabbard section extending from the proximal extension to the distal end. The scabbard section defines a longitudinally extending linear slot. The blade has a first end, a second end, and a cutting edge. The first end is pivotally mounted on the handle assembly such that the second end travels in an arc upon pivoting of the blade between a folded configuration, and an unfolded configuration of the cutting tool, in which the blade extends at least partially forward from the handle assembly with the cutting edge removed from the scabbard section and exposed for use.

### TECHNICAL FIELD

The present disclosure relates to cutting tools and accessories thereof. More particularly, the present disclosure relates to a cutting tool system having a folding cutting tool for near use and an optional pole for extended reach.

### BACKGROUND

A number of folding saws for pruning already exist in the market, but they do not address all the customers'needs in one convenient product. Hand saws with built-in scabbards are available in the marketplace, but they are generally speaking relatively small, and lack the ability to be attached to a pole for extended reach and use.

Some products combine a pole with a folding saw, but lack any modularity, which prevents the user from using poles with different attachments for different purposes. Some users climb trees and ladders where cut is needed in a location inaccessible from the ground. However, currently available products neither accommodate safe handling aloft nor safe climbing with a saw in hand or otherwise safely carried. In some cases a second worker on the ground is available to assist a climber by handing up tools after or during an ascent and receiving the tools after a cutting operation so a climber can descend. However, current pole saws have fixed exposed blades, which presents a cut hazard for climbers and their assistants alike.

Additionally, while the arborist is aloft, there is occasionally the need for keeping the saw handy, in close enough range for easy reaching, but away enough when not in use so that they can do other activities. But again, pole saws currently in the marketplace leave the saw exposed, which again presents a hazard for the arborist. While some tools do include a hook for hanging or manipulating branches, they not have a provision to add a tether. Arborists also very frequently need to reach and manipulate things beyond their anatomical reach while aloft, such as to reach a rope, or to pull a limb just cut to help it get dislodged so it can fall to the ground.

Saw blades in general are constantly exposed to all sorts of situations that deteriorate them and reduce their useful life. Equipment items are typically dropped in truck beds or job boxes for transportation. The impacts of such handling affect the blade (dings, bends, kinks, etc.), and can actually damage and/or deteriorate the cutting teeth. Exposure to the elements can corrode the blade material, again reducing its useful life.

Many arborists prefer that a blade be protected by a scabbard while not in use, and/or remain vertical (hanging from a tree limb for example) so as to reduce the possibility of trips and cuts if a pole saw otherwise lays on the ground. Scabbards do exist to promote safety and to reduce adverse effects on a blade when a tool is stowed, leaned, or stored. But available scabbards are separate items from the blades for which they are intended, and thus are not practical for immediate use, and are usually just left behind or lost.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

A cutting tool system according to at least one embodiment includes a cutting tool and optionally a longitudinally extending pole or other accessories, the cutting tool being inventive and advantageous with and without the pole or other accessories. The cutting tool includes a handle assembly and a blade. The handle assembly has a rearward proximal extension, a forward distal end longitudinally opposite the proximal extension, and a scabbard section extending from the proximal extension to the distal end. The scabbard section defines a longitudinally extending linear slot. The blade has a first end, a second end opposite the first end, and a cutting edge extending from proximal the second end toward the first end. The first end is pivotally mounted on the distal end of the handle assembly such that the second end travels in an arc around the first end upon pivoting of the blade around the first end between a folded configuration of the cutting tool, in which at least the cutting edge is received longitudinally extending linear slot of the scabbard section, and an unfolded configuration of the cutting tool, in which the blade extends at least partially forward from the handle assembly with the cutting edge removed from the scabbard section and exposed for use.

The cutting tool may include a limb hook connected to, and extending at least laterally from, the handle assembly.

The limb hook may include a bidirectional end member defining a rearward recess and a forward notch.

In some examples, the rearward recess defines a depth, the forward notch defines a depth, and the depth of the rearward recess is greater than the depth of the forward notch.

A loop may be connected to the limb hook for attaching a tether to the cutting tool.

The limb hook may include an arcuate forward edge that curves laterally and rearwardly from a back edge of the scabbard section of the handle assembly, the back edge of the scabbard section being laterally opposite the longitudinally extending linear slot.

In some examples and uses of the cutting tool system, a longitudinally extending pole has a distal portion connected to the rearward proximal extension of the handle assembly of the cutting tool.

The cutting tool may further include a ferrule mounted on the rearward proximal extension of the handle assembly for mounting the cutting tool to a pole or other accessory.

The ferrule in some examples defines a male ferrule by including: a proximal insertion end for mounting the cutting tool to a pole, the proximal insertion end having a tapered tip; and a distal end opposite the proximal tapered insertion end, the distal end connected to the rearward proximal extension of the handle assembly.

The proximal insertion end of the male ferrule in at least example includes a cylindrical portion extending from the tapered tip toward the a distal end of the male ferrule.

The cylindrical portion of the male ferrule can include a lock hole for receiving a fastener when mounting the cutting tool to a pole.

The cutting tool system may include a female ferrule having a distal end configured to receive the tapered tip and cylindrical portion of the proximal insertion end of the of the male ferrule.

A latch having a lock pin is carried by the female ferrule in some examples, the lock pin biased to automatically engage a lock hole in the cylindrical portion of the male ferrule when the proximal insertion end of the of the male ferrule is inserted into the distal end of the female ferrule.

The latch may include a spring clip attached to the female ferrule and carrying the lock pin, the spring clip biasing the lock pin into a locking position.

During insertion of the proximal insertion end of the of the male ferrule into the distal end female ferrule, the tapered tip of the male ferrule can move the lock pin from its locking position against a force of the spring clip. Upon the lock pin reaching the lock hole in the cylindrical portion of the male ferrule, the spring clip can return the lock pin to the locking position thereby automatically engaging the lock hole and male ferrule.

The blade may include a mounting hole for pivotally mounting the first end of the blade on the distal end of the handle. The blade may include a circular arc channel centered around the mounting hole for receiving a stop member attached to the handle. The circular arc channel includes a first notch end defining a contact surface for abutting the stop member when the blade is pivoted around the first end thereof to a fully open position of the blade defining the unfolded configuration of the cutting tool.

The blade can include a channel opening for receiving the stop member into the channel to install the blade onto the distal end of the handle, optionally without removal of the stop member from the handle assembly.

The circular arc channel can include a second notch end defining a contact surface for abutting the stop member when the blade is pivoted around the first end thereof to a fully closed position of the blade defining the folded configuration of the cutting tool.

The channel opening may be defined circumferentially, with respect to the mounting hole, between the first notch and the second notch for receiving the stop member into the channel to install the blade onto the distal end of the handle while the stop member is attached to the handle.

A pivot fastener by which the first end of the blade is pivotally and removably mounted on the distal end of the handle assembly, can include a shank having an axle portion received in the mounting hole of the blade and a threaded portion removably attaching the pivot fastener to the handle assembly.

A retainer may be attached to the handle assembly, with the pivot fastener trapped by the retainer such that the pivot fastener is attached to the handle assembly when the threaded portion is disengaged therefrom, preventing loss of the pivot fastener.

In some examples, the scabbard section defines a receiving gap dividing the forward distal end into two distal extensions between which the first end of the blade is pivotally mounted on the distal end of the handle assembly.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a perspective view of a cutting tool system, according to at least one embodiment, ready for use.

FIG. 2 is a perspective view of a cutting tool system of FIG. 1, with the cutting tool thereof in a folded configuration for safe handling.

FIG. 3 is a side view of the cutting tool system in the configuration of FIG. 2.

FIG. 4 is a side view of the separated cutting tool of the system of FIG. 1 with the blade thereof in a stowed position in relation to a scabbard section thereof according to the folded configuration of the cutting tool for safe handling.

FIG. 5 is a perspective view of the separated cutting tool with the blade in an extended position in relation to the scabbard section according to the unfolded configuration of the cutting tool ready for use.

FIG. 6 is a front view of the separated cutting tool of FIG. 5, taken in a working plane of the tool viewing the cutting edge of the blade.

FIG. 7 is a side view of the separated cutting tool of FIG. 5, taken perpendicular to the working plane of the tool viewing a first lateral side of the blade.

FIG. 8. is a rear view of the separated cutting tool of FIG. 5, taken in the working plane of the tool viewing the back of the blade opposite the cutting edge thereof.

FIG. 9 is an exploded perspective view of the cutting tool system of FIG. 1.

FIG. 10 is a second lateral side view of the blade, taken perpendicular to the working plane of the tool and opposite the view direction of FIGS. 3 and 7.

FIG. 11 is a perspective view of a pivot fastener and a stop member by which, respectively, the blade is pivotally attached and rotationally limited in a pivoting range, according to at least one embodiment of the cutting tool system of FIG. 1.

FIG. 12 is a cross-sectional view of the stop member of FIG. 11 in an unlocked position with respect to pivoting of the blade.

FIG. 13 is a cross-sectional view of the stop member of FIG. 11 in a locked position with respect to pivoting of the blade.

FIG. 14 is perspective view of a spring by which the stop member is biased into a blade locking position.

FIG. 15 is a side view, in partial cross section, of a convenient releasable pivot fastener according to at least one embodiment.

FIG. 16 is a side view of a cutting tool according to another embodiment, taken perpendicular to the working plane of the tool viewing a first lateral side of the blade.

FIG. 17 is a view of the cutting tool of FIG. 15, taken in a working plane of the tool viewing the cutting edge of the blade.

FIG. 18 is a perspective view of the cutting tool of FIG. 16.

FIG. 19 is a side view of a male ferrule according to another embodiment.

FIG. 20 is a second side view of the male ferrule of FIG. 19.

FIG. 21 is a perspective view of the male ferrule of FIG. 19.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, all features throughout the drawings and descriptions should be taken as cumulative and inclusive, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

A cutting tool system 10 according to at least one embodiment illustrated in the drawings is shown as generally extending along a longitudinal axis 5 defined at least as along an elongate pole 12 component of the system. A padded protective tip 14 mounted on a user end of the pole 12 is described herein as at a proximal end 16 of the pole, which further has an intermediate portion 20 for variable user handling and a distal portion 22 to which other components of the system are illustrated and described herein as attached. The terms proximal and distal serve as an intuitive convention in these descriptions for the pole and other components without limiting such components to such terms.

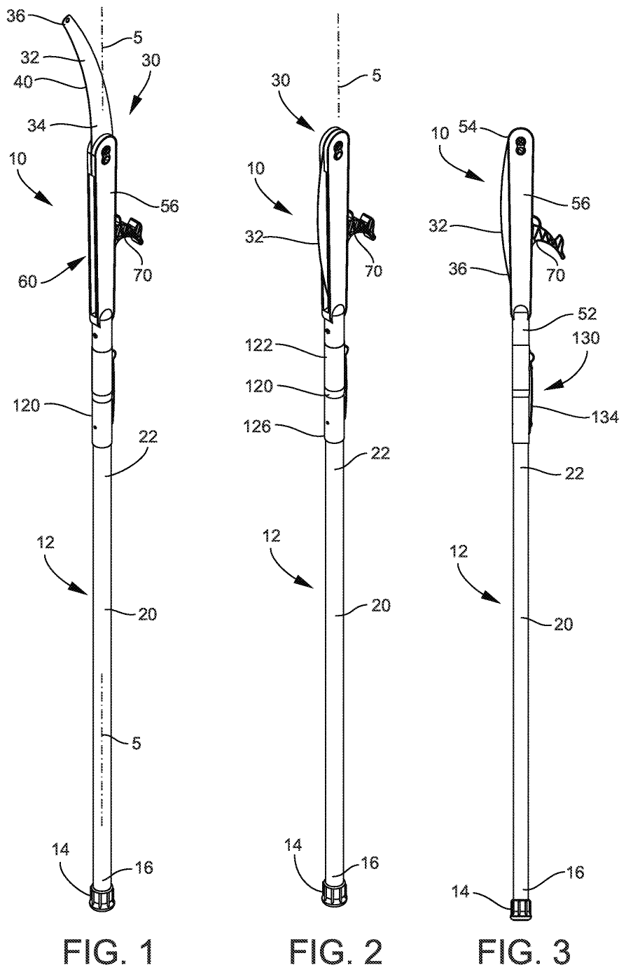

The terms rearward and forward are similarly respectively used, for example, to describe that a user grasping the pole 12 can move the cutting tool assembly 10 forward along the longitudinal axis 5 to advance the extended blade 32 (FIG. 1), and can move the cutting tool 10 assembly oppositely rearward, these coordinated movements resulting in a sawing action of the blade 32 when engaged with a work piece such as the limb of a tree of other growth for pruning.

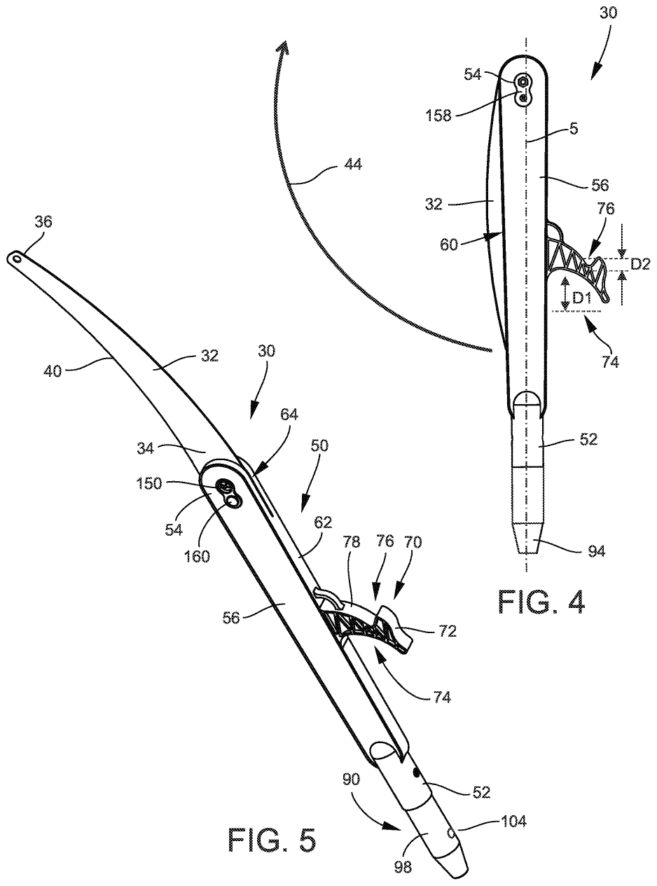

In the embodiments illustrated and described, the cutting tool 30 is releasably mounted on the pole 12 (FIGS. 1-3) to extend the reach of a user, and is separated from the pole for use of the cutting tool 30 (FIGS. 4-8) by hand or other mounting. The pole 12 and cutting tool 30 may be components, useful together and otherwise, of a range of products having interchangeability among some of the tools and accessories thereof according to user preferences.

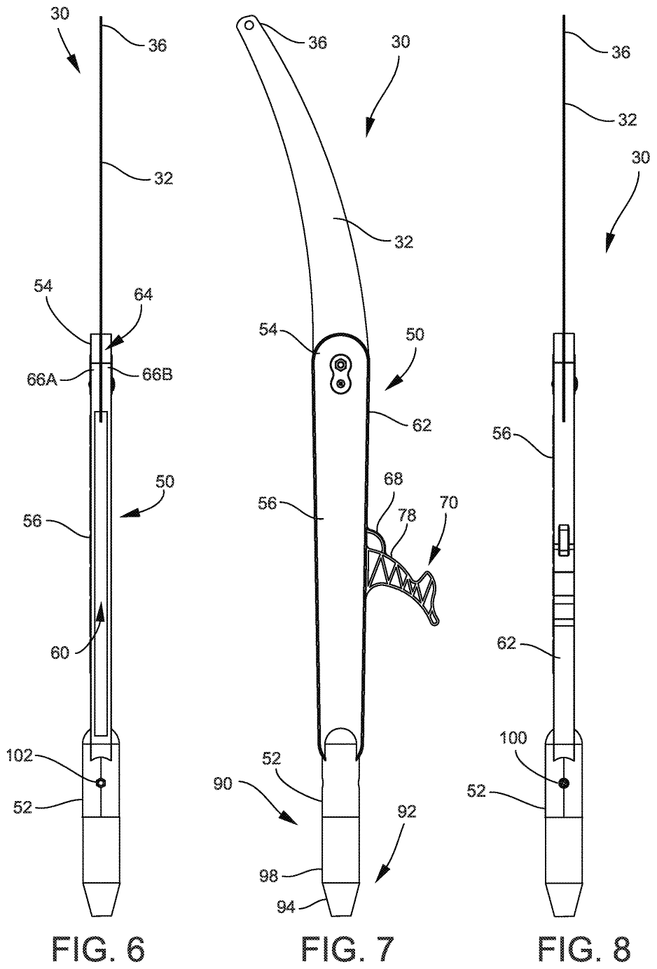

The cutting tool 30 has a handle assembly 50 (FIG. 5) with a rearward proximal extension 52, a forward distal end 54 longitudinally opposite the proximal extension, and a scabbard section 56 extending from the proximal extension 52 to the distal end 54. The scabbard section 56 defines a longitudinally extending linear slot 60 (FIG. 6) for receiving the blade 32 in a stowed and safe manner (FIGS. 2-3). The proximal extension 52 of the handle assembly 50, together with the male ferrule portion 90 form an actual handle. The idea is that a user can grab hold of the tool in this portion and use the tool as a hand tool without the need for attaching it to a pole. This section is deliberately designed long enough to comfortably accommodate a hand.

The blade 32 has a first end 34, a second end 36 opposite the first end, and a cutting edge 40 extending from first end 34 and toward the second end 36. The first end 34 of the blade 32 is pivotally mounted on the distal end of the handle assembly 50 such that the second end 36 travels in an arc 44 (FIG. 4) upon pivoting the blade 32 around the first end 34. A range of rotational travel of the blade 32 is defined between a folded configuration of the cutting tool 30 (FIG. 4), in which at least the cutting edge 40 is received longitudinally extending linear slot 60 of the scabbard section 56, and an unfolded configuration of the cutting tool 30 (FIG. 5), in which the blade 32 extends at least partially forward from the handle assembly 50 with the cutting edge 40 removed from the scabbard section 56 and exposed.

The cutting tool 30 includes many novel and advantageous features, especially the synergy of which provides a highly effectively, versatile, and safe tool for uses according to the creativity and skill of one who wields to tool. For example, the cutting tool 30 includes a multi-function limb hook 70 (FIG. 5) connected to the handle assembly 50. The limb hook 70 extends laterally from scabbard section 56 of the handle assembly 50 in the illustrated embodiment of the cutting tool 30. The limb hook 70 has a bidirectional end member 72, defining a rearward recess 74 and a forward notch 76, for multi-use manipulation of limbs, large and small, a vines and other items and elements.

The limb hook 70 can be used to hang the cutting tool system 10 from a limb or other structure while not in use. This is another way of keeping the cutting tool 30 accessible if not immediately needed while aloft. The limb hook 70 can also be used to keep the cutting tool system 10 vertical and out of the way as a safety precaution, instead of having the system 10 and/or tool 30 lay on the ground posing a trip and/or cut hazard. The limb hook 70 can also be used to pull or push a limb after being cut to help dislodge it and allow it to come down. The hook can also be used to pull things closer to the user while aloft. For example, some users may use it to pull a rope closer to them, so they can access something being lifted up to them, or ease in climbing further up or down.

The rearward recess 74 and a forward notch 76 have separate distinct entry directions and dimensions. For example, the rearward recess 74 is open rearward toward the proximal extension 52, and has a depth D1 (FIG. 4). The forward notch 76 is open forward toward the distal end 54, and has a depth D2. In the illustrated embodiment, the depth D1 of the rearward recess 74 is greater than the depth D2 of the forward notch 76, which can facilitate intuitively engaging larger items for pulling by the rearward recess and smaller items for pushing by the forward notch.

A loop 68 (FIG. 7) is connected to the forward edge of the limb hook 70 at the base thereof, for attaching a tether to the cutting tool 30. Also, the limb hook 70 includes an arcuate forward edge 78 (FIG. 5) that curves laterally and rearwardly from a back edge 62 of the scabbard section 56 of the handle assembly 50, the back edge 62 of the scabbard section being laterally opposite the longitudinally extending linear slot 60. Thus, the limb hook 70 is intuitively opposite the cutting edge of the blade in use, and out of the way of the opening and closing action of the blade 32.

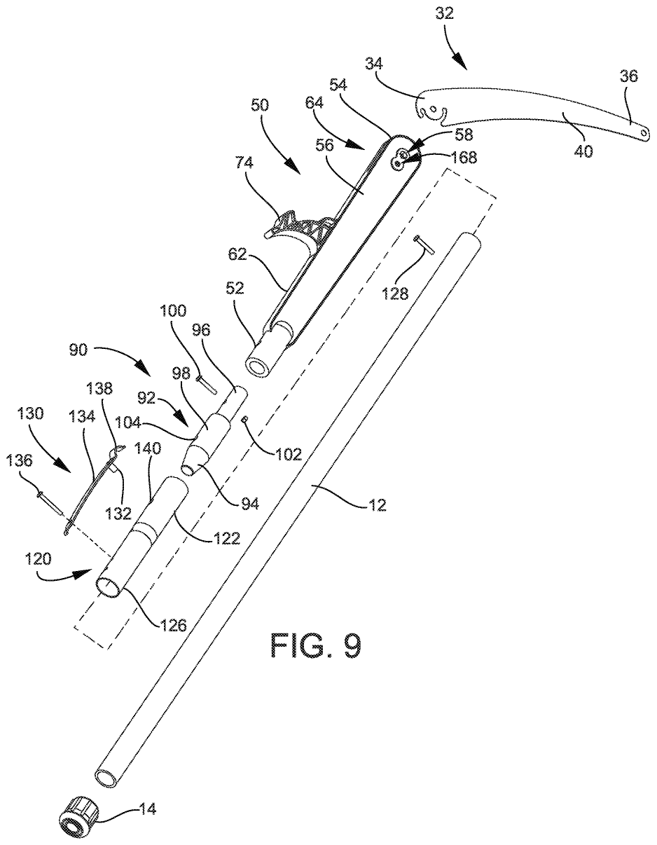

The cutting tool 30 is useful separate from a pole or other accessory. Some features, for example the limb hook 70 and loop 68 may be of particularly advantage when the cutting tool 30 is mounted on an accessory such as the illustrated pole 12 (FIGS. 1-3). The cutting tool 30, in the illustrated embodiment, includes a ferrule 90 (FIG. 7) mounted on the rearward proximal extension of the handle assembly 50 for mounting the cutting tool 30 to a pole or other accessory. The mounted ferrule 90 defines a male-type ferrule by including a proximal insertion end 92 for mounting the cutting tool 30 to a pole, the proximal insertion end 92 having a tapered tip 94. The mounted male ferrule 90 has a distal end 96 (FIG. 9) opposite the insertion end 92, the distal end connected to the rearward proximal extension 52 of the handle assembly 50. In other embodiments of the ferrule geometry may be reversed, such that the distal end 96 looks like a tube to receive proximal extension 52, which may look like a solid stud.

In the illustrated embodiment of FIG. 9, the distal end 96 of the male ferrule 90 is cylindrical and diametrically reduced in relation to a cylindrical portion 98 of the proximal insertion end 92 of the ferrule 90. The distal end 96 is inserted into the tubular terminus of the proximal extension 52 of the handle assembly 50 and retained by a laterally inserted fastener 100, illustrated as a bolt fastened by a nut 102 in FIG. 9. This assembles the cutting tool 30 as a useful unitary item for use as a tool and enables the mounting of the cutting tool 30, on at least the distal portion 22 of the longitudinally extending pole 12 of the drawings.

The cylindrical portion 98 of the proximal insertion end 92 of the male ferrule 90 extends from the tapered tip 94 toward the inserted distal end 96 thereof. The cylindrical portion 98 of has an lock hole 104 (FIGS. 5, 9) for receiving a fastener, pin, or other element when mounting the cutting tool 30 to a pole or other accessory. For releasably connecting the male ferrule 90 and cutting tool 30 therewith to the pole 12, or other accessory in other embodiments, the cutting tool system 10 further includes a female ferrule 120 having a tubular distal end 122 (FIG. 9) configured to receive the tapered tip 94 and cylindrical portion 98 of the proximal insertion end 92 of the of the male ferrule 90.

An automatically locking and manually releasable latch 130 (FIGS. 3, 9) including a lock pin 132 (FIG. 9) is carried by the female ferrule 120. The lock pin 132 is biased to automatically engage the lock hole 104 in the cylindrical portion 98 of the male ferrule 90 when the proximal insertion end 92 of the of the male ferrule is inserted into the distal end 122 of the female ferrule 120.

In particular, the latch 130 is illustrated as having a spring clip 134 (FIGS. 3, 9) with a rearward proximal end attached by a fastener 136 (FIG. 9), such as bolt, to the female ferrule 120. A forward distal portion 138 of the spring clip 134 carries the lock pin 132, and biases the lock pin into a locking position, at which the lock pin is extended radially through a clearance hole 140 (FIG. 9) through the wall of the tubular distal end 122 of the female ferrule 120. During insertion of the proximal insertion end 92 of the male ferrule 90 into the tubular distal end 122 of the female ferrule 120, the tapered tip 94 of the male ferrule 90 encounters the lock pin 132 and moves the lock pin, radially away from the central longitudinal axis, from its locking position against the force of the spring clip 134. Upon the lock pin 132 reaching the lock hole 104 in the cylindrical portion 98 of the male ferrule, upon alignment of the clearance hole 140 and lock hole 104, the spring clip 134 returns the lock pin 132 to the locking position by pressing the lock pin into the lock hole 104, thereby automatically engaging the lock hole.

The inventive ferrule joint system, including the male ferrule 90, the female ferrule 120, and the automatic latch 130, provides an automatic and releasable engagement between the two mating ferrules (90, 120), without requiring expertise or much force to actuate a connection correctly. Locking and retention are maintained by the spring clip 134, which exerts enough force so the lock pin 132 will not be dislodge from the lock hole 104 unintentionally. For use to release the latch, and disjoin the ferrules, the forward distal terminus of the distal portion 138 of the spring clip is formed as a hook by which the forward end of the spring clip can be pulled radially outward against the bias force thereof. By such user action on the hook, the lock pin 132 can be withdrawn from the lock hole 104 and thereby allow the male ferrule 90 to be removed from the female ferrule 120.

The female ferrule 120 has a tubular proximal end 126 for mounting an accessory or tool. In the use depicted in the drawings, the female ferrule 120 is mounted on the pole 12 by insertion of the terminus of the distal portion 22 into a tubular proximal end 126 of the female ferrule 120, which is further fixed to the pole by a fastener 128 (FIG. 9) illustrated as a rivet.

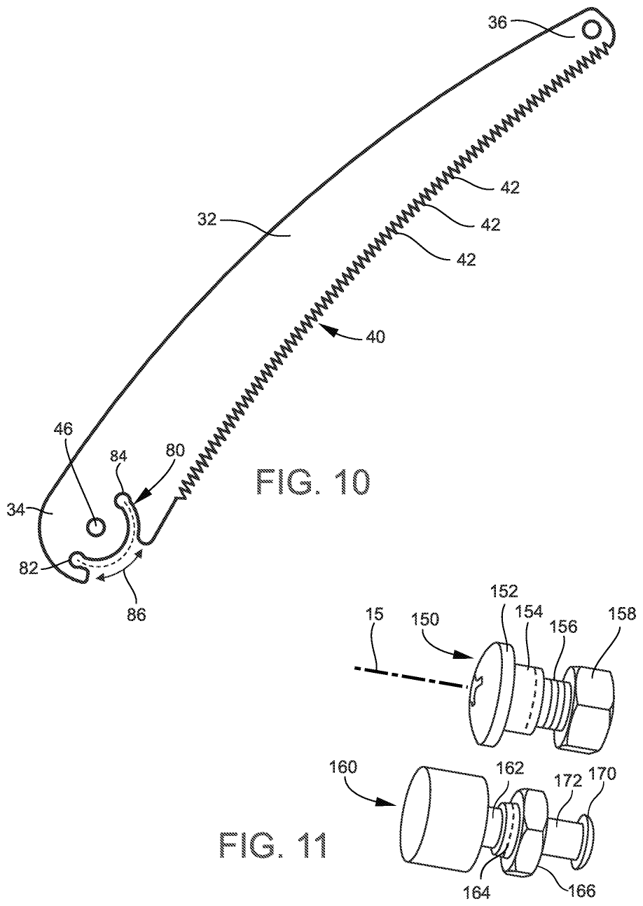

FIG. 10 shows a blade 32, according to at least one embodiment, separated from the cutting tool 30, for example for cleaning, repair, or replacement. FIG. 10 shows an arrangement of triangular cutting teeth 42 along the cutting edge 40 of the blade 32 for illustration of at least one embodiment. Many types of cutting teeth are within the scope of these descriptions and may be made available to consumers wherever the cutting tool system 10, the cutting tool 30, and accessories and variations thereof are available. The blade 32 can be configured with the characteristics prized by professional arborists, such as a length effecting a thirteen inch cutting edge, a material such as double thick steel, a durable finish such as hard chrome plating, and treated cutting teeth such as impulse hardened tri-edge teeth.

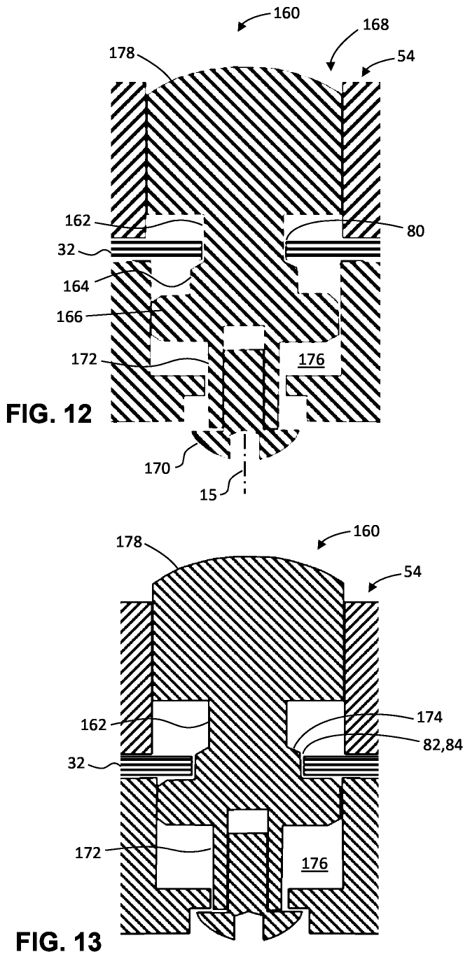

The blade 32 has a mounting hole 46 for pivotally mounting the first end 34 of the blade on the distal end of the handle assembly 50. The blade 32 is pivotally attached to the handle assembly 50, in the assembled condition of the cutting tool 30, by a pivot fastener 150, an embodiment of which is shown in FIG. 11 as a shoulder bolt. The illustrated pivot fastener 150 (FIG. 11) includes a shank having a head 152, an axle portion 154 received in the mounting hole of the blade 32, and a threaded portion 156. The threaded portion removably attaches the pivot fastener 150 to the handle assembly 50, with the axle portion 154 within the mounting hole 46. In the illustrated embodiment, the threaded portion 156 engages a nut 158 trapped in a matingly shaped recess in a lateral side of the distal end of the handle assembly 50. The shank head 152 is turned as a bolt head, for example by a Phillips driver with respect to the illustrated embodiment, to engage the threaded portion 156 with threads of the nut 158. In other embodiments, the pivot fastener may have other configurations, and for example may be a bolt or screw with a head turned when needed by hand without the use of a tool. For example, the pivot fastener can be a thumb screw. The axle portion 154 serves as an axle as the second end of the blade 32 travels in the arc 44 (FIG. 4) as the first end 34 pivots around a pivot axis 15 (FIG. 11), which is defined by the pivot fastener and is perpendicular to the longitudinal axis 5.

Movement of the blade 32 relative to the handle assembly 50 is rotationally limited in a pivoting range at least by a stop member 160 (FIG. 11) in the illustrated embodiment. The stop member 160 is captured by the distal end of the handle assembly 50, having a shank 162 extending laterally and parallel to the pivot fastener 150, positioned between the pivot fastener 150 and the scabbard section 56. The stop member 160 has a collar 164 on the shank, and diametrically enlarged relative to the shank, for engaging and locking corresponding notch ends defined by the blade 32, as described below, at the fully open position (FIG. 5) and fully closed (FIG. 4) positions.

A receiving gap 64 (FIGS. 5, 6, 9) defining the working plane of the blade divides the forward distal end 54 of the handle assembly 50 into two distal extensions 66A, 66B (FIG. 6) between which the first end 34 of the blade 32 is pivotally mounted on the distal end of the handle assembly 50 by the pivot fastener 150. The receiving gap 64 is continuous with the receiving slot 60 of the scabbard section 56 of the handle assembly 50, and is dimensioned as laterally more narrow than the receiving slot. The receiving gap 64 maintains the distal end of the blade 32 in the working plane. The receiving slot 60 accommodates the remainder of the blade 32 in various conditions, some of which may include bends and imperfections due to wear, and accommodates various types of saw teeth, with reference to the cutting edge 40 of the blade 32. Some teeth may have cutting tips diverged slightly from the planar sides of the blade 32 by design and/or teeth that have imperfections according to use. Both the pivot fastener 150 and stop member 160 span the receiving gap 64, strengthening the two distal extensions (66A, 66B) by mutual support.

The blade 32 has a circular arc channel 80 (FIG. 10) centered around the mounting hole 46 for receiving the stop member 160 attached to the handle assembly. The circular arc channel 80 has a first notch end 82 defining a contact surface for abutting and engaging the stop member 160, particularly the collar 164 thereof, when the blade 32 is pivoted around the first end 34 thereof to the fully open position of the blade 32 defining the unfolded configuration of the cutting tool 30. The circular arc channel 80 includes a second notch end 84 defining a contact surface for abutting and engaging the stop member 160, particularly the collar 164 thereof, when the blade 32 is pivoted around the first end 34 thereof to a fully closed position of the blade 32 defining the folded configuration of the cutting tool 30, thereby preventing persistent contact of the cutting edge 40, and particularly the distal tip thereof, with the interior of scabbard section of the handle assembly when folded.

The stop member 160 is installed in a staged mounting hole 168 (FIGS. 9, 12) through the handle assembly 50, between the mounting hole 58 and scabbard section 56. The stop member 160 reciprocates by lateral translation, parallel to the pivot axis 15, permitting the collar 164 to disengage (FIG. 12) and engage (FIG. 13) either notch end 82 or 84. The first end of the blade 32 and the distal end 54 of the handle assembly are represented in part in FIGS. 12-13. The opening in the blade in FIGS. 12-13 represents the first notch end 82 when the blade reaches the fully open position (FIG. 1), and represents the second notch end 84 when the blade reaches the fully closed position (FIG. 2). Each notch end 82,84 is expanded relative to the channel 80 to receive and engage the collar 164. The width of the channel in the plane of the blade is dimensioned to receive the shank 162, but is too narrow to receive the collar 154.

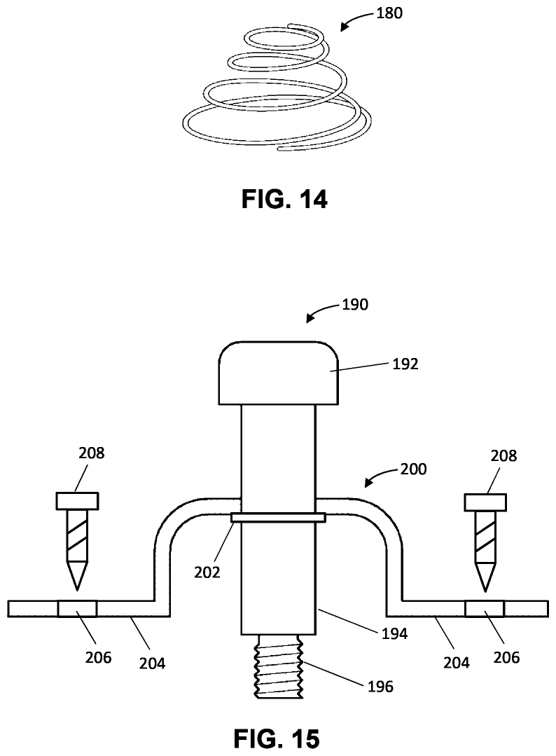

The stop member 160 has an integral fixed nut 166 adjacent the collar 164. The fixed nut 166 is received by and non-rotationally engages the distal end 54 of the handle assembly. A bolt 170 threadingly engages an internally threaded post 172 extending from the fixed nut to assemble the stop member onto the handle assembly. This traps the stop member 160 as attached to the handle assembly, but permits its reciprocating movement parallel the pivot axis 15 between a blade-locked position (FIG. 13) at which the collar 164 is received by a notch end 82,84, and a blade-unlocked position (FIG. 12) at which the shank 162 is received by the arc channel 80. As the blade is pivoted, the collar 162 slides along edges of the channel 80, until reaching a notch end 82,84. A compression spring 180 (FIG. 14) is trapped in a space 176 around the post 172, biasing the stop member toward the blade-locked position (FIG. 13), thus automatically locking the blade in either the fully open position upon the stop member encountering the first notch end 82, or automatically locking the blade in the a fully closed position upon the stop member encountering the second notch end 84. An end 174 of the collar facing the shank 162 is tapered as frustoconical to guide transition to the blade-locked position as the collar enters either notch end 82,84 and automatically locks the blade.

The stop member 160 has a head 178 opposite the post 172 and bolt 170. The head 178 serves as a button for manual displacement of the stop member 160 from the blade-locked position (FIG. 13) against the force of the compression spring 180 residing in the space 176.

The embodiment of the pivot fastener 150 in FIG. 11 is removable from the cutting tool 30, for replacement of the blade 32, by turning the shank head 152 to disengage the pivot fastener 150 from the nut 158. For blade replacement, the mounting hole 46 thereof is aligned with the corresponding mounting hole 58 (FIG. 9) through the distal end 54 of the handle assembly 50 and the pivot fastener is passed therethrough and retightened.

Due to advantageous features of the blade 32 as illustrated, the stop member 160 need not be removed from the handle assembly 50 when the blade is to be separated from the cutting tool 30. The blade 32 includes a channel opening 86 (FIG. 10), for receiving the stop member 160 into the channel 80 to install the blade onto the distal end of the handle assembly. Thus, the blade 32 can be removed for cleaning, repair, or replacement, by temporary removal of the pivot fastener 150, while the stop member 160 remains fixed spanning the receiving gap. For example, to install a new blade, the user arranges the blade 32 in its approach to the handle assembly 50 with the channel opening 86 facing the distal end of the handle assembly 50 so the stop member 160 can pass into the arc channel 80 during installation of the blade 32. See for example the relative relation of the blade 32 to the handle assembly 50 in FIG. 9, with the blade in an orientation corresponding to intermediate a full folded and fully unfolded position, thereby orienting the channel opening to receive the stop member. During this operation, a user can press the head 178 to align the shank 162 with the plane of the blade. Once the shank 162 is within the arc channel 80, the user can release the head 178 and the blade can be pivoted to any preferred position.

FIG. 15 illustrates a releasable pivot fastener 190, according to an alternative embodiment, having features differentiated from the pivot fastener 15 of FIG. 11. The pivot fastener 190 is illustrated as a shoulder bolt, which includes a head 192, a shank having an inner axle portion 194 received in the mounting hole of the blade 32, and a threaded portion 196, which engages the nut 158 as described with reference to the pivot fastener 190. The shank head 192 can be turned to disengage the pivot fastener 190 from the nut 158, for example for replacement of the blade 32, as described in the preceding with reference to the pivot fastener 150. Advantageously, the releasable pivot fastener 190 is trapped by a retainer illustrated as a cap 200, which is slidably mounted on an outer portion of the shank between the head 192 and a clip 202 fixed onto the shank. The cap 200 has a mounting plate 204 that is to be attached to the handle assembly 32, for example by way of mounting holes 206 through the plate by fasteners 208, illustrated as screws or bolts. The pivot fastener 190 can thus be attached to the cutting tool 30 and used similarly as the pivot fastener 150, and is advantageously attached to the handle assembly by the retainer (cap 200 in FIG. 15) when the threaded portion 196 is disengaged. Thus, the pivot fastener 290 is attached to the cutting tool by the retainer preventing misplacement of the fastener during, for example, replacement of the blade 32.

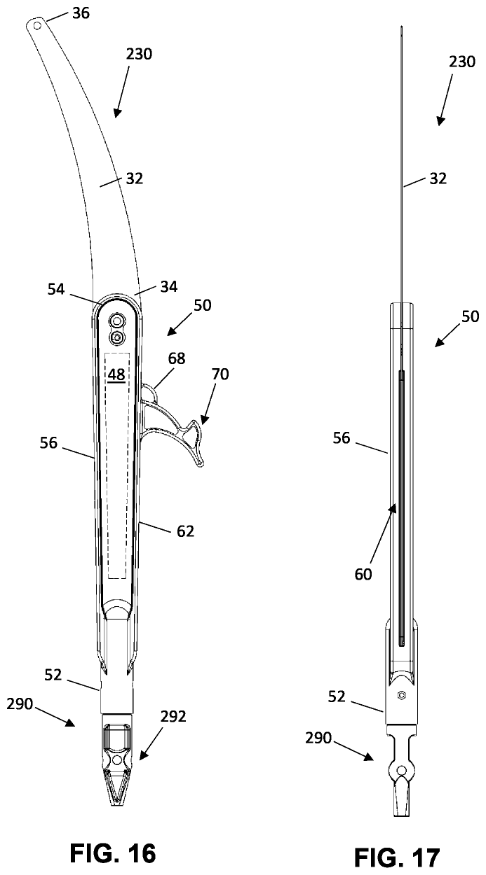

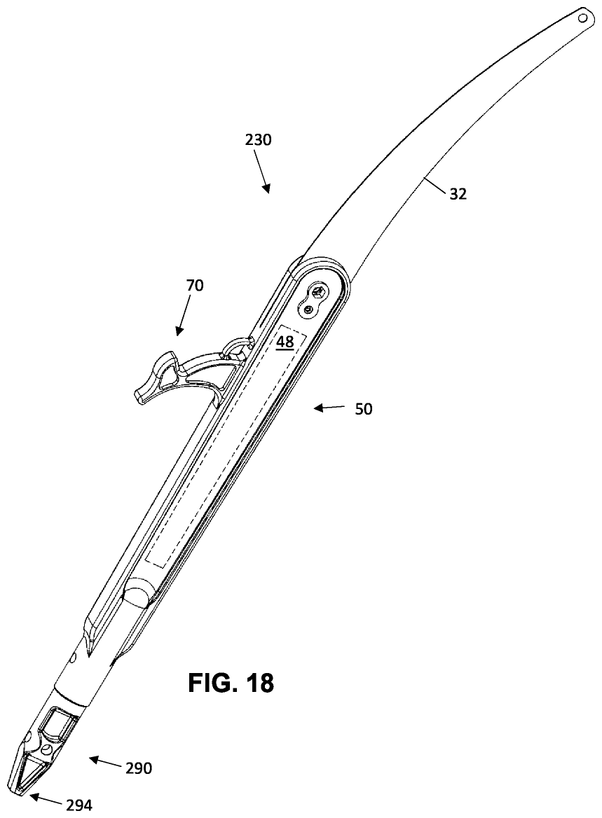

FIGS. 16-18 illustrate a cutting tool 230 according to another embodiment, differentiated from the above descriptions for example at least by way of the male ferrule 290. The lateral sides of handle assembly 50 are shown in FIGS. 16 and 18 as having indicia areas 48, marked in dashed line, representing various feature examples, including but not limited to: raised or sunken logo lettering; graphics; labeling; instructions for safety, use, maintenance, and/or ordering; an indicia or markings of any kind. The indicia areas 48, when provided raised, sunken, or otherwise textured indicia or other features, facilitate grip when the cutting tool is grasped by hand at the handle assembly.

The features and functions of the cutting tool 230, except those expressly illustrated or described as different, are sufficiently similar to those already described in the preceding descriptions of the cutting tool 30 such that separate description here is not needed. The slot 60 (FIG. 17) for receiving the blade 32 within the scabbard section 56 of the handle assembly 50 of the cutting tool 230 is narrowed relative to the corresponding slot 60 (FIG. 6) with reference to the cutting tool 30.

As in the preceding descriptions, the distal end 296 of the male ferrule 290 is dimensioned for insertion into the tubular terminus of the proximal extension 52 of the handle assembly 50. The proximal insertion end 292 of the male ferrule 290 is useful for coupling the cutting tool 230 to a pole for extending reach. Also, the proximal extension 52 of the handle assembly 50, together with a proximal end 292 of the male ferrule 290, form a handle the user can grasp for use of the cutting tool 230 by hand without a pole.

Multi-functional contours of the male ferrule 290 facilitate a retaining grip when used by hand without needlessly tiresome hand pressure applied. The tapered tip 294 (FIG. 18, 20-21) of the male ferrule 290 has opposing side ramped guide surfaces 298 that ease insertion into the female ferrule 120 and move the lock pin 132 from its locking position during insertion against the force of the spring clip 134. Upon the lock pin 132 reaching either of the two opposing lock holes 104 aligned with the respective opposing guide surfaces 298, the spring clip 134 returns the lock pin 132 to the locking position as already described, automatically engaging the two mating ferrules (290 in FIGS. 18, 120 in FIG. 9).

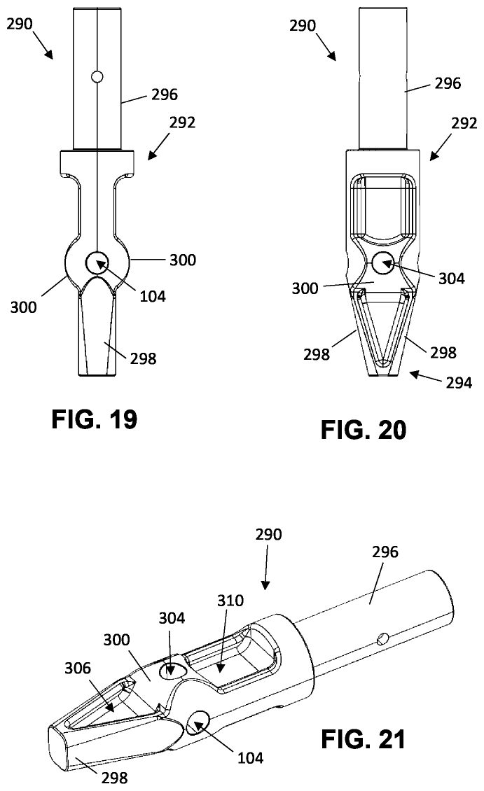

Similarly, the male ferrule 290 has opposing bulges 300 (FIGS. 18-21) to move the lock pin 132 from its locking position against the force of the spring clip 134 during insertion. Upon the lock pin 132 reaching either of the two opposing lock holes 304 through the maxima of the respective opposing bulges 300, the spring clip 134 returns the lock pin 132 to the locking position, automatically engaging the two mating ferrules (290, 120). Thus, during insertion in any of several angles of the male ferrule 290 relative to the ferrule 120, the lock pin 132 can automatically engage any one of four lock holes when mounting the cutting tool 230. Use of the automatically locking and manually releasable latch 130 (FIGS. 3, 9), as described above, is thus facilitated by the male ferrule 290.

The male ferrule 290 has proximal recesses 306 (FIG. 21) between the opposing side ramped guide surfaces 296 and rearward of the bulges 300. Distal recesses 310 are forward of the bulges 300. The recesses 306 and 310, in cooperation with the bulges 300, serve as contours of the male ferrule to facilitate a retaining grip when used by hand.

The variability of the described and illustrated cutting tool system, and embodiments thereof coming to mind and thus within the full scope of these descriptions, facilitate the cutting tool and accessories thereof being a flexible multi-use modular system. The cutting tools 30 (FIGS. 4-8) and 230 (FIGS. 16-18) can be used in close work, at a distance by use of the pole 12 (FIGS. 1-3), and can be customized by the user with reference at least to what type of blade is used, the type and/or length of the pole used, and single stage poles, and multi-staged telescoping poles. A tether can be attached to the loop 68 and to the user, or to a tree limb, so as to keep the cutting tool 30 and/or system 10 available but at a safe distance and out of the way, for example while climbing or performing another activity while aloft, or to facilitate the delivery of the tool from ground level to a climber with a rope and pulley system. Due to the cumulative and inclusive nature of all contents of this disclosure, the term cutting systems refers at least to embodiments having the cutting tool 30 and to embodiments having the cutting tool 230.

The folding aspects of the cutting tool 30 allow the blade 32 to be stowed away within the handle assembly 30, which essentially doubles as a scabbard. This built-in scabbard eliminates the need for a second carry (scabbard or sheath) item to protect the blade 32 whenever stowing is necessary or wanted.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A cutting tool system comprising:
a cutting tool comprising:
a handle assembly comprising a rearward proximal extension, a forward distal end longitudinally opposite the proximal extension, and a scabbard section extending from the proximal extension to the distal end, the scabbard section defining a longitudinally extending linear slot;
a blade comprising a first end, a second end opposite the first end, and a cutting edge extending from proximal the second end toward the first end, wherein the first end is pivotally mounted on the distal end of the handle assembly such that the second end travels in an arc around the first end upon pivoting of the blade around the first end between a folded configuration of the cutting tool, in which at least the cutting edge is received longitudinally extending linear slot of the scabbard section, and an unfolded configuration of the cutting tool, in which the blade extends at least partially forward from the handle assembly with the cutting edge removed from the scabbard section and exposed.

2. The cutting tool system of claim 1, the cutting tool further comprising a limb hook connected to, and extending at least laterally from, the handle assembly, the limb hook comprising a bidirectional end member defining a rearward recess and a forward notch.

3. The cutting tool system of claim 2, wherein:
the rearward recess defines a depth;
the forward notch defines a depth; and
the depth of the rearward recess is greater than the depth of the forward notch.

4. The cutting tool system of claim 2, further comprising a loop connected to the limb hook for attaching a tether to the cutting tool.

5. The cutting tool system of claim 2, wherein the limb hook comprises an arcuate forward edge that curves laterally and rearwardly from a back edge of the scabbard section of the handle assembly, the back edge of the scabbard section being laterally opposite the longitudinally extending linear slot.

6. The cutting tool system of claim 1, further comprising a longitudinally extending pole having a distal portion temporarily connected to the rearward proximal extension of the handle assembly of the cutting tool.

7. The cutting tool system of claim 1, the cutting tool further comprising a ferrule mounted on the rearward proximal extension of the handle assembly for mounting the cutting tool to a pole.

8. The cutting tool system of claim 7, the ferrule defining a male ferrule and comprising:
a proximal insertion end for mounting the cutting tool to a pole, the proximal insertion end having a tapered tip; and
a distal end opposite the tapered insertion end, the distal end connected to the rearward proximal extension of the handle assembly.

9. The cutting tool system of claim 8, wherein the proximal extension of the handle assembly, together with the proximal insertion end of the male ferrule, form a handle a user can grasp for use of the cutting tool by hand without a pole.

10. The cutting tool system of claim 9, wherein the proximal insertion end of the male ferrule comprises a lock hole for receiving a fastener when mounting the cutting tool to a pole.

11. The cutting tool system of claim 9, further comprising a female ferrule having a distal end configured to receive the tapered tip and cylindrical portion of the proximal insertion end of the of the male ferrule.

12. The cutting tool system of claim 11, further comprising a latch comprising a lock pin carried by the female ferrule, the lock pin biased to automatically engage a lock hole when the proximal insertion end of the of the male ferrule is inserted into the distal end of the female ferrule.

13. The cutting tool system of claim 12, the latch further comprising a spring clip attached to the female ferrule and carrying the lock pin, the spring clip biasing the lock pin into a locking position, and wherein:
during insertion of the proximal insertion end of the of the male ferrule into the distal end female ferrule, the tapered tip of the male ferrule moves the lock pin from its locking position against a force of the spring clip; and
upon the lock pin reaching the lock hole in the lock hole of the male ferrule, the spring clip returns the lock pin to the locking position thereby automatically engaging the lock hole.

14. The cutting tool system of claim 1, wherein:
the blade comprises a mounting hole for pivotally mounting the first end of the blade on the distal end of the handle;
the blade comprises a circular arc channel centered around the mounting hole for receiving a stop member attached to the handle; and
the circular arc channel comprises a first notch end defining a contact surface for abutting the stop member when the blade is pivoted around the first end thereof to a fully open position of the blade defining the unfolded configuration of the cutting tool.

15. The cutting tool system of claim 14, the blade comprises a channel opening for receiving the stop member into the channel to install the blade onto the distal end of the handle.

16. The cutting tool system of claim 15, wherein the circular arc channel comprises a second notch end defining a contact surface for abutting the stop member when the blade is pivoted around the first end thereof to a fully closed position of the blade defining the folded configuration of the cutting tool.

17. The cutting tool system of claim 16, wherein the channel opening is defined concentrically, with respect to the mounting hole, between the first notch and the second notch for receiving the stop member into the channel to install the blade onto the distal end of the handle while the stop member is attached to the handle.

18. The cutting tool system of claim 17, further comprising a pivot fastener by which the first end of the blade is pivotally and removably mounted on the distal end of the handle assembly, the pivot fastener comprising a shank having an axle portion received in the mounting hole of the blade and a threaded portion attaching the pivot fastener to the handle assembly.

19. The cutting tool system of claim 18, further comprising a retainer attached to the handle assembly, wherein the pivot fastener is trapped by the retainer such that the pivot fastener is attached to the handle assembly when the threaded portion is disengaged therefrom.
